(19) United States
(12) Patent Application Publication
(10) Pub. No.: US 2006/0082226 A1
(43) Pub. Date: Apr. 20, 2006

(54) Magnetic linear drive

(75) Inventor: Carsten Protze, Dresden (DE)

Correspondence Address: MORRISON & FOERSTER LLP, 1650 TYSONS BOULEVARD, SUITE 300, MCLEAN, VA, 22102, US

(73) Assignee: SEIMENS AKTIENGESELLSCAFT, Munchen (GE)

(21) Appl. No.: 10/549,307

(22) PCT Filed: Feb. 25, 2004
(86) PCT No.: PCT/DE04/00366

§ 371 Date: Sep. 16, 2005

(30) Foreign Application Priority Data
Mar. 17, 2003 (EP) 103 13 144.2

(51) Int. Cl. H02K 41/00; H02K 35/00

(52) U.S. Cl. 310/14; 310/15

(57) ABSTRACT

The invention relates to a magnetic linear drive comprising a base. A first displaceable part can be displaced in relation to the base. A second displaceable part is mounted on the first displaceable part. Both the first displaceable part and the second the second displaceable part can be displaced along an axis. A contact piece of a medium or high-voltage switch can be displaced by means of the movement of the first displaceable part and the second displaceable part.

### CLAIM FOR PRIORITY

This application claims the benefit of priority to German Application No. 10313144.2 which was filed in the German language on Mar. 17, 2003, the contents of which are hereby incorporated by reference.

### TECHNICAL FIELD OF THE INVENTION

The invention relates to a magnetic linear drive, and in particular, to a magnetic linear drive having a base and a first movable part.

### BACKGROUND OF THE INVENTION

One such magnetic linear drive is known, for example, from the Swiss Patent Specification CH 184 977. The known linear drive has a plurality of windings, into which an armature is drawn when current flows through the windings. The known armature is formed in a number of parts, with each part of the armature being mounted in a guide sleeve which is in each case attached to the magnet housing and to the pole shoes. The individual parts of the armature can be moved relative to one another, but only by a certain amount, which is governed by an air gap. A movement of the individual parts of the armature is in each case provided, in the form of a chain, in a fixed sequence in order to omit a movement to an element that is to be driven.

The movement which can be tapped off from the known drive can take place only on the basis of a single pattern, which is fixed and is predetermined by the design. Flexible use of the drive is thus possible only to a restricted extent. Furthermore, the armature must be assembled from a very large number of individual parts in order to achieve a large linear movement, so as to produce a correspondingly large number of air gaps between the individual parts and to produce a large linear movement overall.

A further magnetic linear drive is known, for example, from European Patent Specification EP 0 830 699 B1. The arrangement has a coil through which a current can flow. A drive rod is moved by the magnetic field originating from the coil, using the force effects on permeable boundary surfaces. The drive rod enters the interior of the coil in the process.

The force effect on the movable part changes depending on the depth to which the drive rod enters the coil. The linear movement of a linear drive such as this is restricted.

### SUMMARY OF THE INVENTION

The invention relates to a magnetic linear drive having a base and having a first movable part, which can be moved along an axis, wherein a first magnetic force effect for movement of the first movable part can be produced between the base and the first movable part, and a second magnetic force effect for movement of the second movable part can be produced between the first movable part and a second movable part which can be moved along the axis.

The present invention discloses a magnetic linear drive of the type mentioned initially such that the movement sequence can be controlled easily, with the movable part having a long linear movement, and a suitable method for operation of a magnetic linear drive such as this.

According to the invention, a magnetic linear drive has a second movable part being mounted such that it can move on the first movable part.

The provision of two movements of two parts which can be moved independently of one another makes it easier to control a movement sequence. A large number of movement profiles can be created by acceleration or deliberate braking of in each case one of the movable parts or corresponding superimposition of the movements of the two movable parts. Furthermore, it is also possible to drive one of the movable parts, so that the magnetic linear drive can produce a limited linear movement. Furthermore, the splitting into linear movement elements of a first movable part and of a second movable part makes it possible to produce a better force profile throughout the entire movement. The magnetic forces which can be produced between the first movable part and the second movable part, as well as between the base and the first movable part, can each be produced independently of one another. The total force requirement for a movement can thus be distributed between a plurality of elements. The magnitude and time profile of any force effect can thus be optimized per se, without directly influencing the other force effect at the same time. Overall, the two magnetic force effects complement one another to form a resultant force effect. A magnetic linear drive such as this can be used as a drive for a medium-voltage or high-voltage switch, in particular for a circuit breaker.

Magnetic force effects can be produced, for example, by a combination of coils through which a current flows, permanent magnets and high-permeability material. Magnetic force effects can easily be matched to the technical requirements. Robust mechanical structures, which are subject to only a small amount of mechanical wear, can in this case be chosen in order to transmit the forces.

Mounting the second movable part on the first movable part makes it possible to couple the movements of the movable parts to one another in a simple manner. The second movable part can be repelled from the first movable part and can thus be moved in a simple manner either at the same time as the first part or at a time after or before any movement of the first part. In comparison to known designs, this makes it possible to produce a sufficiently large force effect over the entire movement distance of the entire movement, with an increased linear movement.

Furthermore, it is advantageously possible to provide for a first and a second permanent magnet to be aligned with respect to one another in such a way that, in a limit position of the magnetic linear drive, the magnetic fluxes of the first permanent magnet and of the second permanent magnet are closed along a common path within a high-permeability multiple part core body.

The use of permanent magnets to secure the positions means that there is no need for mechanical latches for the magnetic linear drive. If the lines of force which originate from the permanent magnet are combined along a common path, then the holding force which originates from one of the permanent magnets is increased. In comparison to a single permanent magnet which produces an increased magnetic force, a plurality of magnetically coupled permanent magnets have the advantage that they can be arranged distributed along a preferred path. It is thus possible to deliberately influence the closed path within a high-permeability core body and to define more precisely the routing of the magnetic flux.

It is advantageously also possible to provide for the field windings to be arranged at a rigid angle with respect to the first movable part.

Arranging the field windings on the first movable part at a fixed angle allows the field windings, which are intended to be driven electrically, to be concentrated on a single part. It is thus possible for the base and the second movable part not to have to have any field windings which have to be driven electrically. This simplifies the design of a magnetic linear drive such as this.

It is also possible to provide for the second movable part to be a plunger-type armature.

For specific applications of a magnetic linear drive, for example for driving contact pieces in a medium-voltage or high-voltage circuit breaker, it may, for example, be possible to provide for the movement which is produced by the first movable part to be used for movement of the contact pieces, and for the movement of the second movable part to be used for compression of a contact-pressure element, which produces a contact-pressure force on the contact pieces of the circuit breaker. The power which is required to produce the contact-pressure force can be produced by means of a simple plunger-type armature. The plunger-type armature is extremely robust, and is virtually free of mechanical wear.

A further advantageous embodiment can provide for each of the movable parts to have an associated field winding.

A movement sequence can be controlled in a simple manner by the association of field windings with each of the movable parts. The force and movement profiles of each of the movable parts can easily be controlled by the design of the field winding, for example by varying the number of turns. The force effects which can be produced between the first moving part and the base, as well as between the first moving part and the second moving part, can thus be adjusted and varied in a simple manner.

Another embodiment of the invention is a method for operation of a magnetic linear drive, which has at least some of the features described above.

A first method provides that during any movement of at least one of the movable parts, a magnetic circuit which is fed jointly by a first permanent magnet and a second permanent magnet is separated within a high-permeability multiple part body into magnetic circuits which are fed separately.

The joint feed to a magnetic circuit from a first and a second permanent magnet on the one hand allows a very high holding force to be produced by the magnetic coupling of two permanent magnets. On the other hand, once the permanent magnets have been separated, they can each be used in their own right to produce holding forces which act independently of one another. For example, depending on the position of the magnetic linear drive, it is possible to produce increased holding forces in one specific position, and for lower holding forces to be required in another position.

A further method specifies that the time sequence of the movements of the first and of the second movable part is influenced by means of a control apparatus, using at least one of the field windings.

A field winding which is deliberately driven makes it possible to deliberately strengthen or to deliberately weaken the forces which occur within the magnetic linear drive. This makes it possible to adapt the force effects of the field windings which are provided for driving the movable parts, without any mechanical intervention in the system. The field winding which is driven by means of the control apparatus can thus be used to produce additional acceleration forces or a braking effect. In this case, it is possible to provide for one and the same field winding to be used to drive one movable part during a movement sequence, and for the drive to be provided by a control apparatus during another movement sequence, in order to produce a braking or accelerating magnetic field.

### BRIEF DESCRIPTION OF THE DRAWINGS

The invention will be described in more detail in the following text with reference to exemplary embodiments, which is illustrated schematically in a drawing, and in which:

FIGS. 1 to 3 show a movement sequence of a magnetic linear drive from an off position to an on position.

FIGS. 4 to 6 show the magnetic linear drive being moved from an on position to an off position.

### DETAILED DESCRIPTION OF THE INVENTION

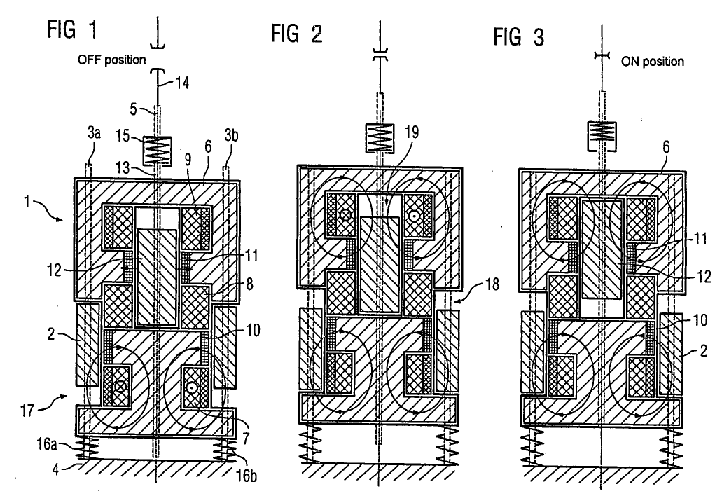

The design of a magnetic linear drive 1 will be described with reference to FIG. 1. The magnetic linear drive 1 has a base 2. The base 2 is part of a high-permeability multiple part core body, and is arranged in a fixed position on guide rods 3a, 3b. The guide rods 3a, 3b are supported on a base plate 4. The guide rods 3a, 3b extend parallel to an axis 5. The magnetic linear drive 1 is formed essentially co-axially with respect to the axis 5, but may also be formed with mirror-image symmetry on a plane. A first movable part 6 is arranged such that it can be moved longitudinally along the axis 5 on the guide rods 3a, 3b. The first movable part 6 is likewise part of the high-permeability core body. The first movable part 6 (with a bold surround) has a recess in which the base 2 engages, so that the longitudinal movement capability of the first movable part 6 along the guide rods 3a, 3b is limited. The movable part 6 has a first field winding 7, a second field winding 8 and a third field winding 9. The field windings 7, 8, 9 each have a large number of turns which surround the axis 5. Ideally, the field windings 7, 8, 9 are arranged coaxially with respect to the axis 5. A first permanent magnet 10 is arranged between the first field winding 7 and the second field winding 8. A second permanent magnet 11 is arranged between the second field winding 8 and the third field winding 9. The first permanent magnet 10 and the second permanent magnet 11 may in this case be in the form of different design embodiments. For example, they may each extend in an annular shape around the axis 5 or may be formed from a large number of magnet elements, whose overall effect in each case results in a first and a second permanent magnet. Both the first permanent magnet 10 and the second permanent magnet 11 are in this case magnetized and arranged in such a way that the magnetization directions of the permanent magnets 10, 11 run radially with respect to the axis 5. In the area of the second field winding 8 and of the third field winding 9, the movable part 6 has a recess through which the second field winding 8 and the third field winding 9 pass. A plunger-type armature 12 is mounted such that it can move in the recess. The plunger-type armature 12 represents a second movable part. The plunger-type armature 12 is connected at a rigid angle to a drive rod 13, which is mounted on the first movable part 6 such that it can move along the axis 5. The drive rod 13 is coupled to a movable contact piece 14 of an electrical contact arrangement. A contact arrangement such as this is, for example, a medium-voltage or high-voltage circuit breaker. The drive rod 13 is coupled to the movable contact piece 14 with the interposition of a compression element 15. An arrangement having a plurality of compression springs 16a, b is provided between the base plate 4 and the first movable part 6 in order to damp a switching-off movement and in order to support a switching-on movement. The compression springs 16a, b are optional elements.

A process for switching on the magnetic linear drive 1 will be described in exemplary form in the following text with reference to FIGS. 1, 2 and 3. When the magnetic linear drive 1 is in the off position, the magnetic lines of force which originate from the first permanent magnet 10 and from the second permanent magnet 11 form a common magnetic circuit (see FIG. 6). The common magnetic circuit in this case passes through a multiple part core body which comprises parts of the base 2, parts of the first movable part 6, and parts of the plunger-type armature 12. The sections in which a magnetic flux is intended to be carried are each formed from high-permeability material. The coupling of the magnetic fields of the first permanent magnet 10 and of the second permanent magnet 11 results in an increased holding force of the first movable part 6 on the base 2, and of the plunger-type armature 12 on the first movable part 6. A direct current is caused to flow through the first field winding 7 in a first direction in order to produce a first force effect between the base 2 and the first movable part 6 (FIG. 1). The first direct-current direction in this case be chosen so as to increase the magnetic flux originating from the first permanent magnet 10. This means that the magnetic circuit, which was previously fed jointly from the first permanent magnet 10 and the second permanent magnet 11, is changed to a non-equilibrium state, so that a force effect is produced between the first movable part 6 and the base 2. This force effect results in closure of a gap 17 between the base 2 and the first movable part 6. At the same time, a further gap 18 is opened (see FIG. 1, after FIG. 2). The production of the further gap 18 breaks the jointly fed magnetic circuit within the multiple part high-permeability core body, and each of the permanent magnets 10, 11 feeds a separate magnet circuit within a high-permeability core body (see FIG. 2). In order to cause the plunger-type armature 12 to move, current must likewise be passed through the third field winding 9 in a first direction. The force effect on the high-permeability boundary surfaces results in a movement of the plunger-type armature 12, and the magnetic gap 19 is closed (see FIG. 2 after FIG. 3). The linear movement of the plunger-type armature 12 moves the movable contact piece 14 to its on position. Furthermore, the compression element 15 is compressed and, as a result of the force effect of the compression element 15, the movable contact piece 14 is pressed with the necessary contact-pressure force against a mating contact piece. In the on position (FIG. 3), the first permanent magnet 10 produces a holding force between the first movable part 6 and the base 2. The second permanent magnet 11 produces a holding force between the plunger-type armature 12 and the first movable part 6.

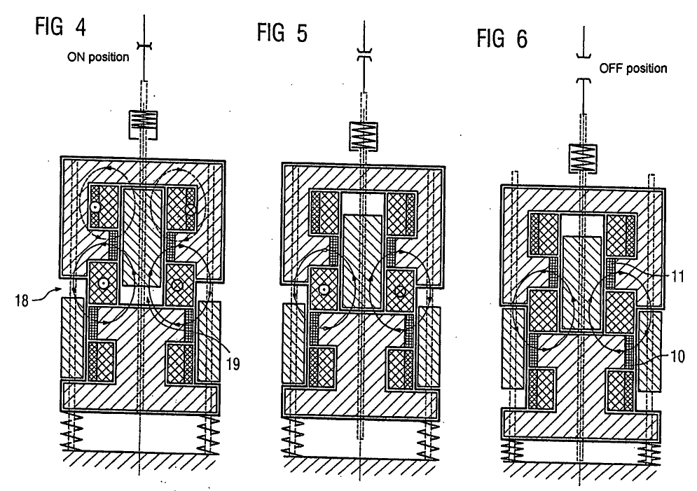

The movement of the magnetic linear drive 1 from an on position to an off position will be described in the following text with reference to FIGS. 4, 5 and 6. Direct current has to flow in a second direction through the second field winding 8 in order to produce a switching-off movement. The direct current in this case be in such a direction that the magnetic fluxes which originate from the two permanent magnets are reinforced, thus assisting and promoting the production of a common magnetic circuit from the first permanent magnet 10 and the second permanent magnet 11. The magnetic force effect between the movable part 6 and the base 2 results in a reduction in the size of the further gap 18. Furthermore, the magnetic gap 19, which is now located in the area of the second field winding 8, is likewise closed. To produce a switching-off movement, current flows through the second field winding 8. The plunger-type armature 12 and the first movable part 6 then move virtually at the same time. In order to co-ordinate the movement sequence of the movement of the first movable part 6 and of the plunger-type armature 12, it is optionally possible to provide for current likewise to be passed through the third field coil 9 in a second direction, by means of a control apparatus. This reinforces the force effect on the plunger-type armature 12, since a magnetic field in the opposite direction to that of the second permanent magnet 11 weakens the magnetic field from the permanent magnet 11, and thus reduces the holding forces between the plunger-type armature 12 at the first movable part 6. This forces the plunger-type armature 12 to move before any movement of the first movable part 6 (see FIG. 4, after FIG. 5). Once the first movable part has also been moved to its off position as a result of current flowing through the second field winding 8, the magnetic lines of force which originate from the first permanent magnet 10 and from the second permanent magnet 11 complement one another to form a common magnetic circuit, which is formed in the high-permeability material of one of the plunger-type armature 12, the first movable part 6 or the base 2. The common magnetic circuit holds the first movable part 6 firmly on the base 2, and holds the plunger-type armature 12 firmly on the first movable part 6.

1. A magnetic linear drive comprising:
a base; and
a first movable part, which can be moved along an axis, wherein a first magnetic force effect for movement of the first movable part is produced between the base and the first movable part, and a second magnetic force effect for movement of a second movable part is produced between the first movable part and the second movable part, which can be moved along the axis, wherein the second movable part is mounted such that it can move on the first movable part.

2. The magnetic linear drive as claimed in claim 1, further comprising a first and a second permanent magnet aligned with respect to one another such that, in a limit position of the magnetic linear drive, the magnetic fluxes of the first permanent magnet and of the second permanent magnet are closed along a common path within a high-permeability multiple part core body.

3. The magnetic linear drive as claimed in claim 1, further comprising field windings arranged at a fixed angle with respect to the first movable part.

4. The magnetic linear drive as claimed in claim 1, wherein the second movable part is a plunger-type armature.

5. The magnetic linear drive as claimed in claim 1, wherein each of the movable parts has an associated field winding.

6. A method for operation of a magnetic linear drive having a base and a first movable part, which can be moved along an axis, wherein a first magnetic force effect for movement of the first movable part is produced between the base and the first movable part, and a second magnetic force effect for movement of a second movable part is produced between the first movable part and the second movable part, which can be moved along the axis, wherein the second movable part is mounted such that it can move on the first movable part, comprising separating a magnetic circuit which is fed jointly by a first permanent magnet and a second permanent magnet within a high-permeability multiple part body into magnetic circuits which are fed separately, during movement of at least on of the movable parts.

7. A method for operation of a magnetic linear drive having a base and a first movable part, which can be moved along an axis, wherein a first magnetic force effect for movement of the first movable part is produced between the base and the first movable part, and a second magnetic force effect for movement of a second movable part is produced between the first movable part and the second movable part, which can be moved along the axis, wherein the second movable part is mounted such that it can move on the first movable part, comprising influencing the time sequence of the movements of the first and of the second movable part by means of a control apparatus, using at least one of the field windings.
